(19) United States
(12) Patent Application Publication
(10) Pub. No.: US 2013/0332371 A1
(43) Pub. Date: Dec. 12, 2013

(54) Systems and methods for jury selection and consulting

(71) Applicant: JUR-EASE, LLC, Kerrville, TX (US)

(72) Inventor: Amos L. Barton, Kerrville, TX (US)

(73) Assignee: Jur-Ease, LLC, Kerrville, TX (US)

(21) Appl. No.: 13/815,630

(22) Filed: Mar. 13, 2013

Related U.S. Application Data
(60) Provisional application No. 61/689,461, filed on Jun. 6, 2012.
(60) Provisional application No. 61/656,363, filed on Jun. 6, 2012.

(51) Int. Cl. G06Q 50/18; G06Q 10/00

(52) U.S. Cl. CPC G06Q 50/18; G06Q 10/00
USPC 705/311

(57) ABSTRACT

A tangible computer-readable medium may include instructions executable by a computer for: receiving personal data regarding each of a plurality of prospective jurors; establishing a plurality of questions to be posed to the plurality of prospective jurors; establishing a plurality of potential answers to each of the plurality of questions; assigning a degree of favorability or unfavorability to each of the plurality of potential answers; receiving a response to each of the plurality of questions from each of the plurality of prospective jurors, each response comprising one of the plurality of potential answers; associating a respective one of the degree of favorability or unfavorability with each of the plurality of prospective jurors based on the response; and generating a representation of the respective one of the degree of favorability or unfavorability for each of the plurality of prospective jurors. Related systems and methods are also disclosed.

### CROSS REFERENCE TO RELATED APPLICATIONS

This application claims priority to U.S. Provisional Application Ser. No. 61/689,461 filed Jun. 6, 2012, and U.S. Provisional Application Ser. No. 61/656,363 filed Jun. 6, 2012. The disclosures of the aforementioned applications are incorporated herein by reference.

### COPYRIGHT NOTICE

This application contains material that is subject to copyright protection. Such material may be reproduced exactly as it appears in Patent and Trademark Office patent files or records. The copyright owner otherwise reserves all rights to such material.

### FIELD

The disclosed systems and methods generally relate to jury selection and consulting and focus groups.

### BACKGROUND

In the fields of jury selection, jury consulting, and focus grouping, there are a number of challenges and needs for improvement. Among other things, attorneys conducting voir dire are challenged to keep track of a large amount of information concerning prospective jurors and to make rapid decisions regarding peremptory strikes and strikes for cause in a relatively short period of time. This challenge may be particularly difficult for persons in small law offices and solo practitioners who do not have large support staffs. Court clerks are also challenged to compile and manage voluminous data associated with the jury selection process and to disseminate the data to appropriate personnel (e.g., attorneys, judges, consultants, legal assistants, etc.). Due to the magnitude and complexity of the jury selection process, it would be beneficial to allow multiple persons to work as a team in the process, but due to the typical restrictions of the courtroom process of voir dire, little if any “on-the-fly” collaboration presently occurs among members of a legal team. As lawsuits often have national or global implications, legal teams often extend beyond the courtroom, but current methodologies do not readily enable meaningful participation by users physically located apart from the court proceedings.

### SUMMARY

The present disclosure addresses the foregoing and other needs by providing computerized systems and methods to assist attorneys, judges, court clerks, and other persons in handling jury selection, mock jury selection, focus groups, and similar consulting processes. Among other things, systems and methods as disclosed herein may substantially simplify and improve the accuracy and efficiency of such processes by pre-coding responses to prospective juror questions and automatically generating a graphical indication of the degree to which a particular prospective juror is favorable or unfavorable to a party based on the responses from the prospective juror, thereby assisting an attorney or other person in deciding which prospective jurors to strike either for cause or on a peremptory basis. In some embodiments, either simultaneously with, prior to, or after receiving such responses from prospective jurors, such systems and methods may permit a user (e.g., an attorney for a party) to enter “ideal” responses to the same set of selected questions (e.g., via a speech, video, case presentation, or the like) presented to prospective jurors, and the user's responses may serve as a benchmark answer representative of an ideal prospective juror from that user's standpoint. The systems and methods may then compare the responses received from each prospective juror to the benchmark data collected from the user and use an algorithm to output a result that represents the degree or extent of departure of each prospective juror from the benchmark. A score for each prospective juror may be calculated by computing the deviation from the benchmark according to the desired algorithm. For example, in some embodiments, the higher the deviation, the less “favorable” the associated prospective juror is determined to be from the party's standpoint, and vice versa.

In some embodiments, a hardware and software solution is provided for real-time gathering, disseminating, performing data analysis, and graphically representing results to users conducting jury selection, focus groups, and mock juries.

In some embodiments, a tangible computer-readable medium may include instructions executable by a computer for: receiving personal data regarding each of a plurality of prospective jurors; establishing a plurality of questions to be posed to the plurality of prospective jurors; establishing a plurality of potential answers to each of the plurality of questions; assigning a degree of favorability or unfavorability to each of the plurality of potential answers; transmitting the plurality of questions to the plurality of prospective jurors; receiving a response to each of the plurality of questions from each of the plurality of prospective jurors, each response comprising one of the plurality of potential answers; associating a respective one of the degree of favorability or unfavorability with each of the plurality of prospective jurors based on the response; and generating a representation of the respective one of the degree of favorability or unfavorability for each of the plurality of prospective jurors. Related systems and methods are also disclosed.

In some embodiments, systems and methods described herein make jury selection more meaningful and statistically driven to maximize the often-limited time an attorney is permitted to engage in voir dire.

In some embodiments, a mechanism may be provided to graphically represent the on-goings of jury selection and enable meaningful participation by users physically located apart from the proceedings. This allows attorneys and other persons “off-site” to see the streaming transcript of the proceedings, see the notations and trending of counsel located in the courtroom, and contribute as though the remote attorney were at counsel table.

In some embodiments, systems and methods may simplify and streamline the method of obtaining extra-judicial background information on the jury panel. A user may submit and obtain extra-judicial background information on the jury panel as it finally exists immediately prior to voir dire. This last minute background check saves the users significantly over any existing process in that the attorneys cannot know in advance who will appear for jury duty, where they will be located within the venire, or if a shuffle will be requested. If desired, an attorney may pay for and obtain extra-judicial computerized background checks on a specified number of prospective jurors, e.g., the first 25 jurors.

In some embodiments, systems and methods may allow compilation and testing of participants' responses in jury selection, focus groups, and mock juries against a user-predetermined set of criteria or standards resulting in a graphical display to the user of the statistical analysis regarding favorable (e.g., shade of green) or unfavorable (e.g., shade of red) ranking of the response and hence the responder.

In some embodiments, systems and methods facilitate gathering and sharing jury data among a network of users to glean statistically significant data and trends in jury selection, focus groups, and mock juries to enhance and refine product development, issue spotting, trial themes, and the selection process generally.

In some embodiments, systems and methods provide a real-time interface for a user to receive up to the second digital data from a court clerk regarding jury panel information.

In some embodiments, systems and methods alleviate the need for data analysis by users conducting jury selection, focus groups, and mock juries while simultaneously trying to conduct an interactively intense data gathering process.

In some embodiments, systems and methods facilitate obtaining discreet answers from responders (e.g., prospective jurors) without requiring a visible or audible response in a group setting, which avoids the negative stimulus observed in group dynamic response distortion.

In some embodiments, systems and methods facilitate batch scanning and attribute responses from questionnaires to the respective responder; attributed responses can be coded to give a graphical representation of favorable or unfavorable on the users' seating chart; to generate data analysis reports for use in jury selection, focus groups, and mock juries.

In some embodiments, systems and methods log for the Official Reporter's Record, or the proceedings of a mock jury, or focus group, the words spoken by participants and the timecoded and synchronized occurrence of non-verbal responses to questions.

In some embodiments, systems and methods allow a user to “hold” or “pause” responses to questioning during jury selection, mock trials, or focus groups. The nature of live responses to questions is that they are temporal and fleeting, often requiring an exercise by the person asking questions to invite responders to “hold up your cards” for an extended period while the person asking questions or staff of said person document the responses. Some systems and methods described herein give a graphical representation of responding persons which can be “held” or “paused” in the system until the user is ready to proceed. The feature enables extended questioning of only those people who responded to an initial question, or may enable an assisting attorney to pause responders to make notes relevant to the question asked while the presenting attorney can proceed with other questioning.

In some embodiments, systems and methods provide an ability to code questions by attorneys and consultants in real-time. Such coding then causes the system to “look” for responders who contemporaneously indicate a response to a stimulus question, and correspondingly categorize such responses as “favorable” or “unfavorable” dependant upon how the question was coded. Such categorizations are then graphically displayed on the user's interface in a unique and quickly interpretable format. Additionally, the unique method of coding questions by the attorney and receiving reponses from prospective jurors discreetly will not “tip-off” opposing counsel to matters considered by the user important as may happen in other systems of jury selection when a lawyer takes special steps to read responders' names or numbers into the record, or stop the proceedings to write down responses.

In some embodiments, hand held response controllers permit attorneys to log responses by venirepersons instantly and without using often limited time by reading responses into the record. The system logs the responses in a format that is synchronized with the transcript to create a record for the court reporter.

Other benefits and advantages may be provided by various embodiments of the systems and methods described herein. Various embodiments may or may not provide all the benefits and advantages described herein.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic diagram of a computerized system configured for practicing methods described herein.

FIG. 2 is a schematic diagram of an exemplary embodiment of a jury selection system configured for practicing methods described herein.

FIG. 3 is a sample computer display screen of a main menu of a GUI of the jury selection system of FIG. 2.

FIG. 4 is a sample computer display screen of a sub-menu of the GUI of FIG. 3.

FIG. 5 is a sample computer display screen of another sub-menu of the GUI of FIG. 3.

FIG. 6 is a sample computer display screen of yet another sub-menu of the GUI of FIG. 3.

FIG. 7 is a sample computer display screen of still another sub-menu of the GUI of FIG. 3.

FIG. 8 is a sample computer display screen of a portion of the GUI of FIG. 3 illustrating a seating chart of prospective jurors.

FIG. 9 is a sample computer display screen of a portion of the GUI of FIG. 3 illustrating information about a prospective juror.

FIG. 10 is another sample computer display screen of a portion of the GUI of FIG. 3 illustrating information about a prospective juror.

FIG. 11 is a sample computer display screen of a portion of the GUI of FIG. 3 illustrating actions that may be taken with respect to prospective jurors.

FIG. 12 is a sample computer display screen of a portion of the GUI of FIG. 3 illustrating a seating chart of prospective jurors and selected jurors.

FIG. 13 is a sample computer display screen of a portion of the GUI of FIG. 3 illustrating another seating chart of prospective jurors.

FIG. 14 is a sample computer display screen of a portion of the GUI of FIG. 3 illustrating a summons for a prospective juror.

FIG. 15A is a diagram illustrating various icons that may be used to characterize a prospective juror.

FIG. 15B is a diagram illustrating further icons that may be used to characterize a prospective juror.

FIG. 15C is a diagram illustrating still other icons that may be used to characterize a prospective juror.

FIG. 16 is a sample computer display screen of a portion of the GUI of FIG. 3 illustrating color-coded responses of prospective jurors based on variances from responses of a benchmark juror.

### DETAILED DESCRIPTION

The following terms as used herein should be understood to have the indicated meanings unless the context requires otherwise.

When an item is introduced by “a” or “an,” it should be understood to mean one or more of that item.

“Communication” means the transmission of one or more signals from one point to another point. Communication between two objects may be direct, or it may be indirect through one or more intermediate objects. Communication in and among computers, I/O devices and network devices may be accomplished using a variety of protocols. Protocols may include, for example, signaling, error detection and correction, data formatting and address mapping. For example, protocols may be provided according to the seven-layer Open Systems Interconnection model (OSI model), the TCP/IP model, or any other suitable model.

“Comprises” means includes but is not limited to.

“Comprising” means including but not limited to.

“Computer” means any programmable machine capable of executing machine-readable instructions. A computer may include but is not limited to a general purpose computer, mainframe computer, microprocessor, computer server, digital signal processor, personal computer (PC), personal digital assistant (PDA), laptop computer, desktop computer, notebook computer, smartphone (such as Apple's iPhone™, Motorola's Atrix™ 4G, and Research In Motion's Blackberry™ devices, for example), tablet computer, netbook computer, portable computer, portable media player with network communication capabilities (such as Microsoft's Zune HD™ and Apple's iPod Touch™ devices, for example), camera with network communication capability, wearable computer, point of sale device, or a combination thereof. A computer may comprise one or more processors, which may comprise part of a single machine or multiple machines.

“Computer readable medium” means an article of manufacture having a capacity for storing one or more computer programs, one or more pieces of data, or a combination thereof. A computer readable medium may include but is not limited to a computer memory, hard disk, memory stick, magnetic tape, floppy disk, optical disk (such as a CD or DVD), zip drive, or combination thereof.

“GUI” means graphical user interface.

“Having” means including but not limited to.

“Interface” means a portion of a computer processing system that serves as a point of interaction between or among two or more other components. An interface may be embodied in hardware, software, firmware, or a combination thereof.

“I/O device” may comprise any hardware that can be used to provide information to and/or receive information from a computer. Exemplary I/O devices may include disk drives, keyboards, video display screens, mouse pointers, joysticks, trackballs, printers, card readers, scanners (such as barcode, fingerprint, iris, QR code, and other types of scanners), RFID devices, tape drives, touch screens, cameras, movement sensors, network cards, storage devices, microphones, audio speakers, styli and transducers, and associated interfaces and drivers.

“Memory” may comprise any computer readable medium in which information can be temporarily or permanently stored and retrieved. Examples of memory include various types of RAM and ROM, such as SRAM, DRAM, Z-RAM, flash, optical disks, magnetic tape, punch cards, EEPROM, and combinations thereof. Memory may be virtualized, and may be provided in or across one or more devices and/or geographic locations, such as RAID technology, for example.

“Module” means a portion of a program.

“Network” may comprise a cellular network, the Internet, intranet, local area network (LAN), wide area network (WAN), Metropolitan Area Network (MAN), other types of area networks, cable television network, satellite network, telephone network, public networks, private networks, wired or wireless networks, virtual, switched, routed, fully connected, and any combination and subnetwork thereof. A network may use a variety of network devices, such as routers, bridges, switches, hubs, repeaters, converters, receivers, proxies, firewalls, translators and the like. Network connections may be wired or wireless, and may use multiplexers, network interface cards, modems, ISDN terminal adapters, line drivers, and the like. A network may comprise any suitable topology, such as point-to-point, bus, star, tree, mesh, ring, and any combination or hybrid thereof.

“Program” may comprise any sequence of instructions, such as an algorithm, for example, whether in a form that can be executed by a computer (object code), in a form that can be read by humans (source code), or otherwise. A program may comprise or call one or more data structures and variables. A program may be embodied in hardware, software, firmware, or a combination thereof. A program may be created using any suitable programming language, such as C, C++, Java, Perl, PHP, Ruby, SQL, other languages, and combinations thereof. Computer software may comprise one or more programs and related data. Examples of computer software may include system software (such as operating system software, device drivers and utilities), middleware (such as web servers, data access software and enterprise messaging software), application software (such as databases, video games and media players), firmware (such as software installed on calculators, keyboards and mobile phones), and programming tools (such as debuggers, compilers and text editors).

“Signal” means a detectable physical phenomenon that is capable of conveying information. A signal may include but is not limited to an electrical signal, an electromagnetic signal, an optical signal, an acoustic signal, or a combination thereof.

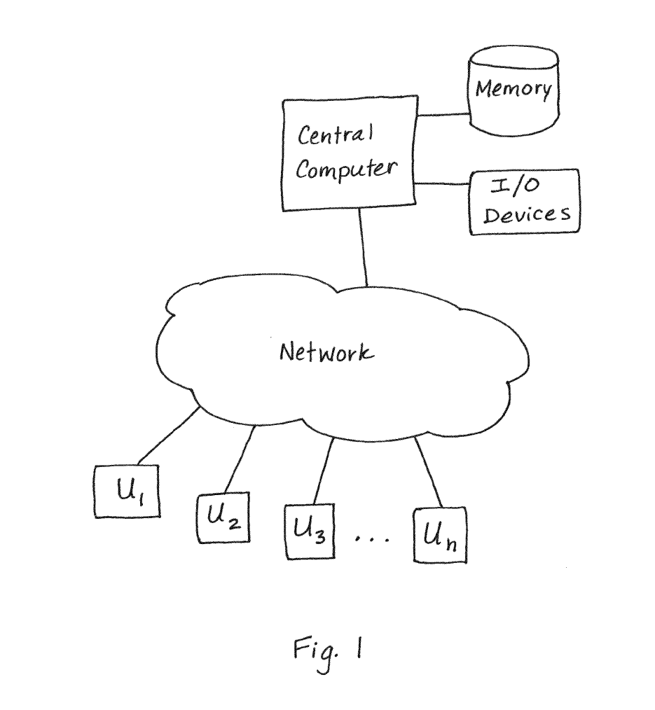

Turning now to the drawings, FIG. 1 illustrates an exemplary computer network for implementing a jury selection system and method as described herein. In the embodiment of FIG. 1, the system comprises a client-server architecture in which one or more central server computers communicates through a network with one or more client computers (U₁, U₂, U₃, . . . Uₙ) that may be used by various users, such as attorneys, judges, court clerks, and other users. In some embodiments, the server may comprise one or more computers or programs that respond to commands or requests from one or more other client computers or programs. The client may comprise one or more computers or programs that issue commands or requests for service provided by the one or more server computers. The server and client computers may be located in or across one or more computers and/or geographic locations. Servers and/or clients may variously be or reside on any type of computer as defined herein and may have or be in communication with various I/O devices, memory storage devices, and other data processing, receiving, and/or transmission devices. Computer programs provided to carry out the methods described herein may reside on the server computers and/or the client computers. In other embodiments, the system may comprise other types of network architecture, such as a peer-to-peer architecture, or any combination or hybrid thereof.

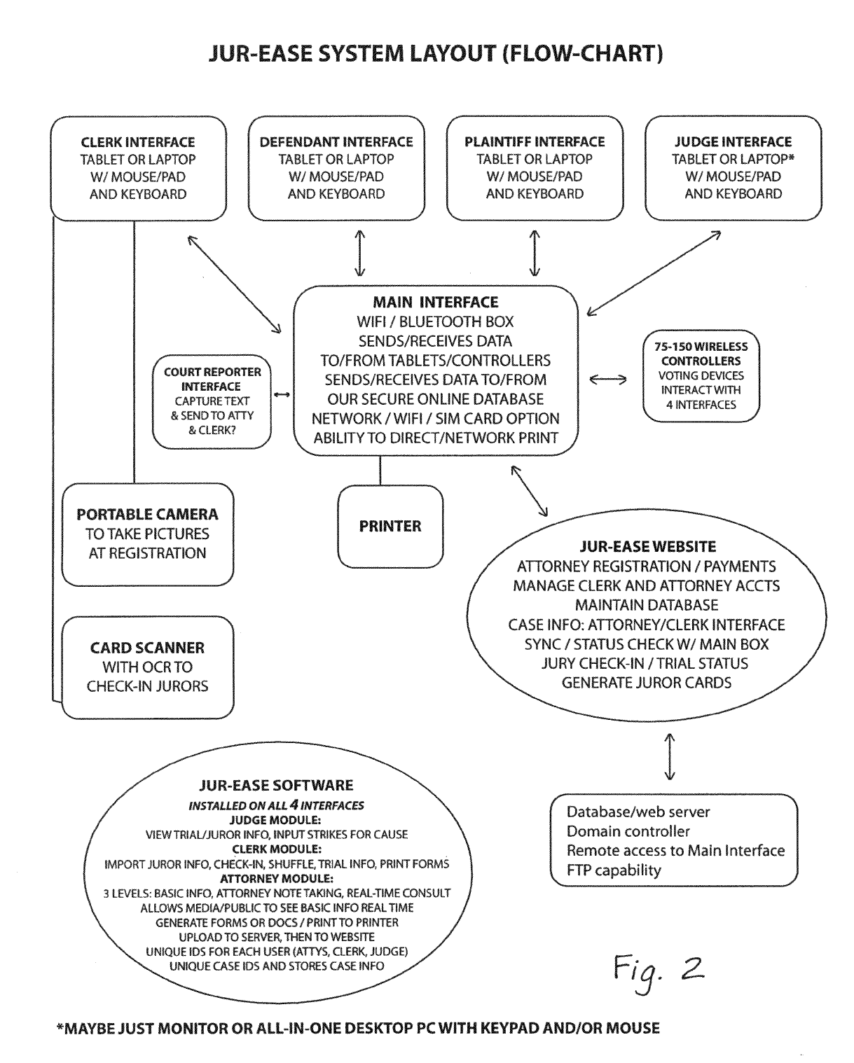

As shown in FIG. 2, an exemplary embodiment of one or more computer programs for implementing a jury selection system and method as described herein may include a main interface or module in communication with a court clerk interface or module, a defendant's attorney interface or module, a plaintiff's attorney interface or module, a judge interface or module, a court reporter interface or module, and a plurality of prospective juror interfaces or modules (indicated in FIG. 2 as wireless controllers or voting devices). Prospective juror interfaces or modules may be dedicated devices devoted to use exclusively for jury selection, consulting, and focus group processes as described herein, or they may be general purpose personal devices (e.g., smartphones, PDAs, tablet computers, notebook computers, or the like) on which suitable program applications may be run (e.g., an app for an iPhone). The same is true of the other interfaces and modules described herein. Each of the various user interfaces (e.g., clerk, judge, attorneys, prospective jurors, court reporter, and the like) may communicate with the main interface as further described herein. In some embodiments, the clerk, defendant, plaintiff, judge, court reporter, and prospective juror interfaces may communicate with a main interface that comprises a separate component with send and receive capability (such as a router, for example), which in turn communicates through a network (such as the Internet, for example) with a central server that comprises a web site on which most or all of the data described herein may reside. Although the main interface and an associated web site are depicted separately in FIG. 2, the web site may be part of the main interface in some embodiments. A camera may be in communication with the court clerk module to allow the court clerk to take photographs of prospective jurors and upload such photographs into the system. A card scanner or other I/O device may be in communication with the court clerk module to allow the court clerk to read in or otherwise input data regarding prospective jurors into the system. Alternatively, prospective juror information (e.g., name, address, age, gender, occupation, citizenship, responses to questions, and the like) may be entered into the system by prospective jurors via a web site or other suitable means. In some embodiments, the system may be a web-based system that is accessible by the various users via the Internet. Of course, other suitable networks may also be used. A printer may be connected to the main interface or any of the other interfaces or modules to enable each respective user to print various information contained in the system. Features described herein for one module or interface may be included in any other module or interface. Although the participants who respond to various questions as described herein are generally referred to as “prospective jurors” or “jurors,” it should be understood that such participants may be any type of participant, such as mock jurors, focus group participants, or the like.

The embodiment of FIG. 2 and other embodiments may provide computerized systems and methods to assist attorneys, judges, court clerks, and other persons in handling jury selection, mock jury selection, focus groups, and similar consulting processes. The main interface or other components may be configured for receiving personal data regarding each of a plurality of prospective jurors (or mock jurors or focus group participants); establishing a plurality of user-defined questions (e.g., entered by an attorney user) to be posed to the plurality of prospective jurors; establishing a plurality of user-defined potential answers (e.g., entered by an attorney user) to each of the plurality of questions; assigning a degree of favorability or unfavorability to each of the plurality of potential answers (e.g., as defined by an attorney user); transmitting the plurality of questions to the plurality of prospective jurors; receiving a response to each of the plurality of questions from each of the plurality of prospective jurors (e.g., entered by each prospective juror), each response comprising one of the plurality of potential answers; associating a respective one of the degree of favorability or unfavorability with each of the plurality of prospective jurors based on the response; and generating a representation (e.g., textual, graphical, or other representation) of the respective one of the degree of favorability or unfavorability for each of the plurality of prospective jurors, which may be displayed on an attorney user's device and may assist the attorney in deciding whether to strike a prospective juror. The main interface or other components may also be configured for receiving a user-defined benchmark answer to the plurality of questions and assigning the degree of favorability or unfavorability to each of the plurality of potential answers based on a degree of departure of the response from the benchmark answer. In some embodiments, the representation of favorability or unfavorability may comprise color, and the degree of favorability or unfavorability may be indicated by a shade of color, as described further below. By providing such pre-defined “coding” of questions and answers and automatically generating a graphical or other indication of favorability or unfavorability based on the responses entered by prospective jurors, the systems and methods described herein may greatly simplify and systematize the job of an attorney in conducting voir dire by automating the collection of relevant juror information, assessing its significance to the attorney's client, and displaying it in a succinct form so that the attorney may act upon it to decide which strikes to make.

Such pre-coded questions and answers may take any of a variety of forms. For example, they may be “yes,” “no,” or “abstain”; numerical (e.g., 1, 2, 3, 4 . . . ); alphabetical (e.g., A, B, C, D, . . . ); textual dialog or commentary in which key words are searched and identified; scaled (e.g., 1-10, 1-100, or the like); or other types of questions and answers.

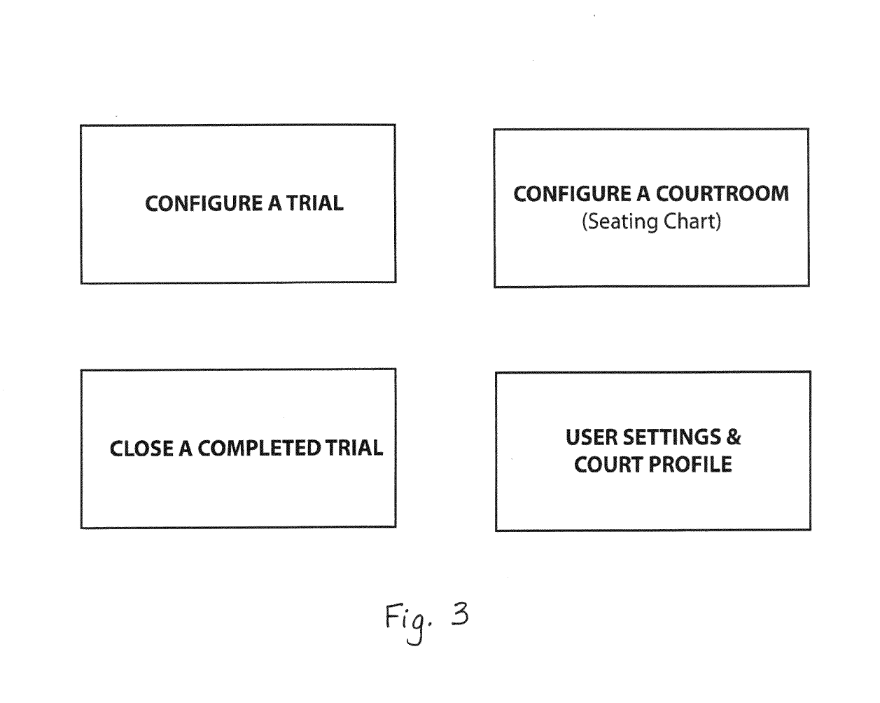

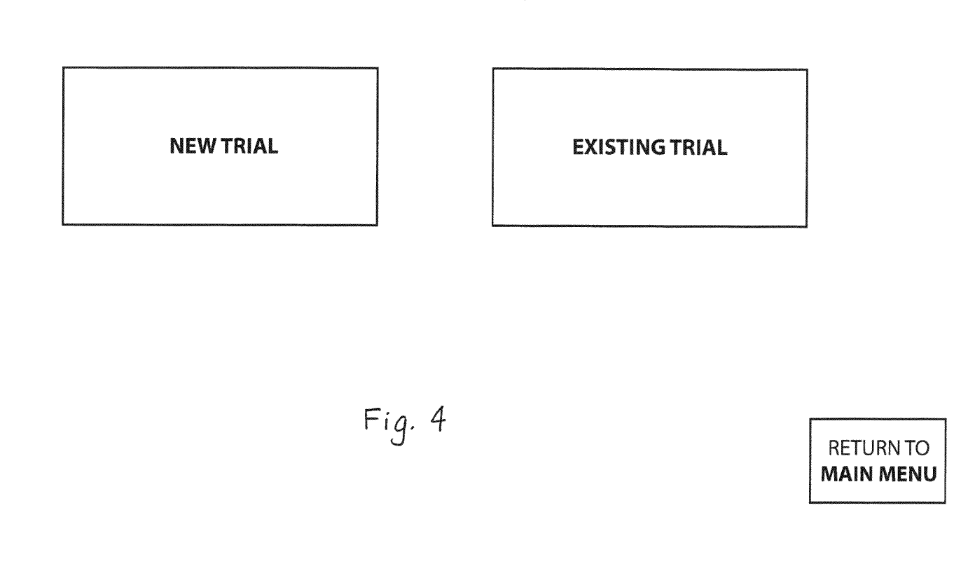

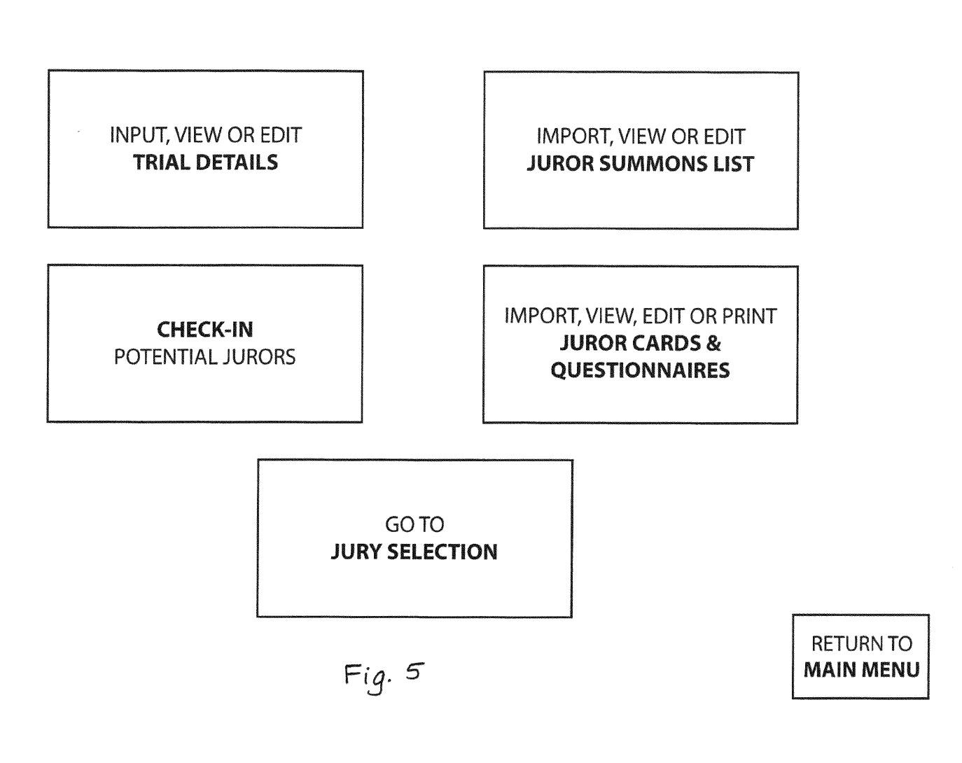

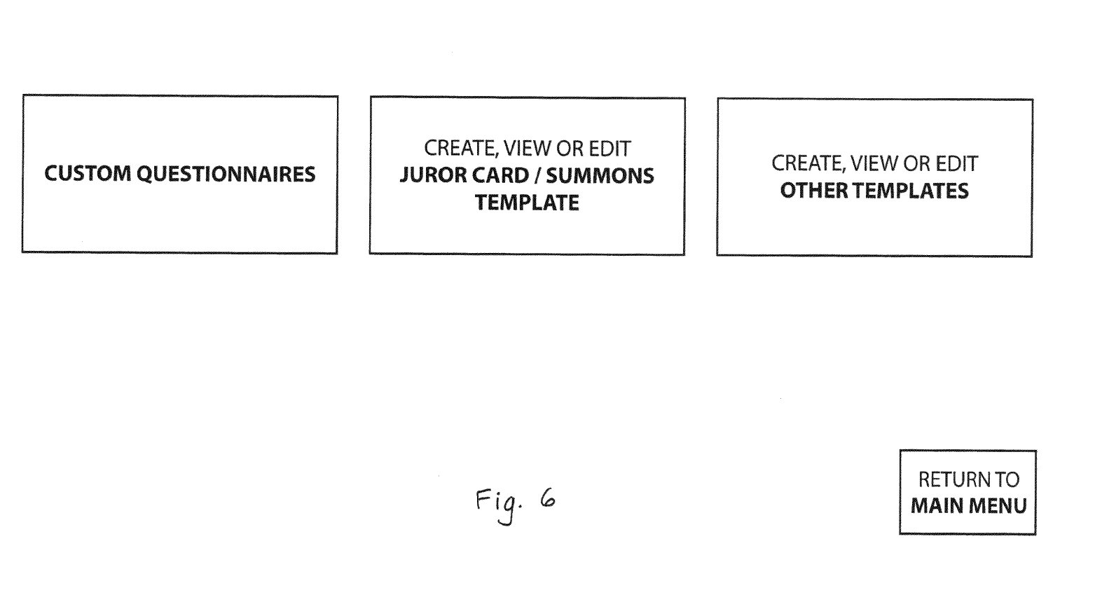

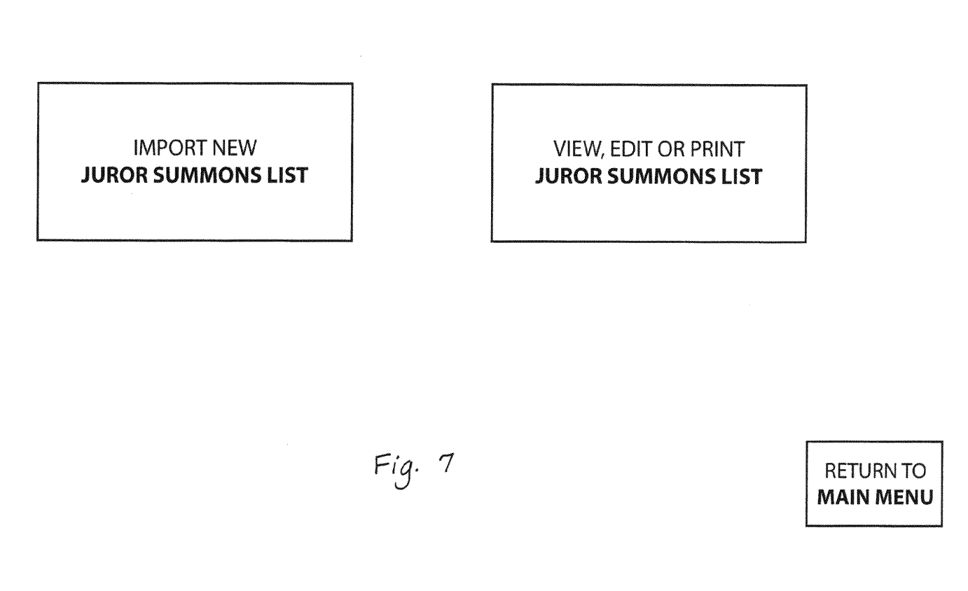

As shown in FIG. 3, a main menu of a GUI for implementing the systems and methods described herein may include selectable buttons for configuring a trial, configuring a courtroom seating chart, closing a completed trial, or selecting user settings and profiles. As shown in FIG. 4, the GUI may also include options for selecting a new trial or selecting an existing trial. As shown in FIG. 5, the GUI may also include selectable options to input, view or edit trial details; import, view or edit juror summons lists; check in potential jurors; import, view, edit or print juror cards and questionnaires; or go to jury selection. As shown in FIG. 6, the GUI may also include selectable options to create or view custom questionnaires; create, view or edit juror card/summons templates; or create, view or edit other templates. As shown in FIG. 7, the GUI may also include selectable options to import new juror summons lists; or view, edit or print juror summons lists.

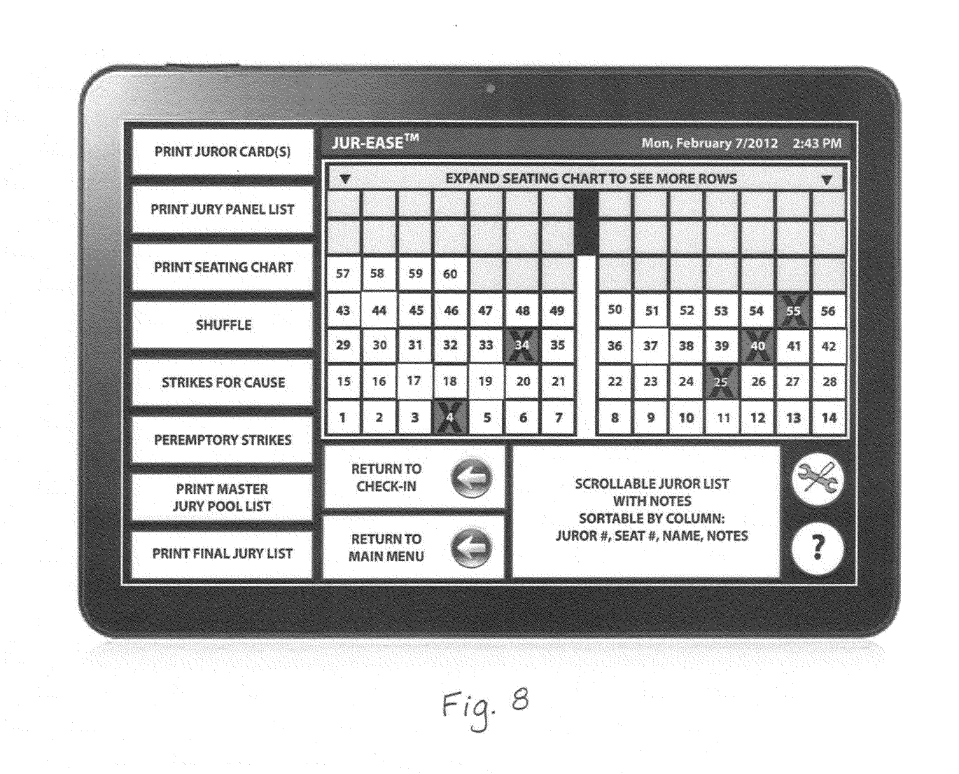

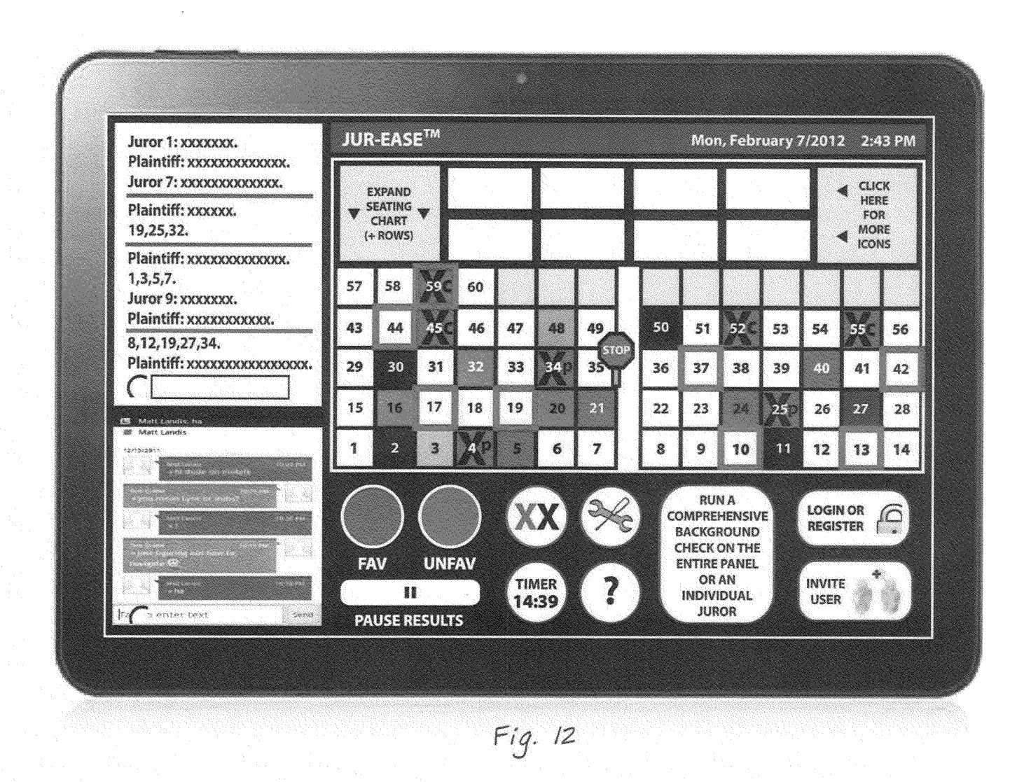

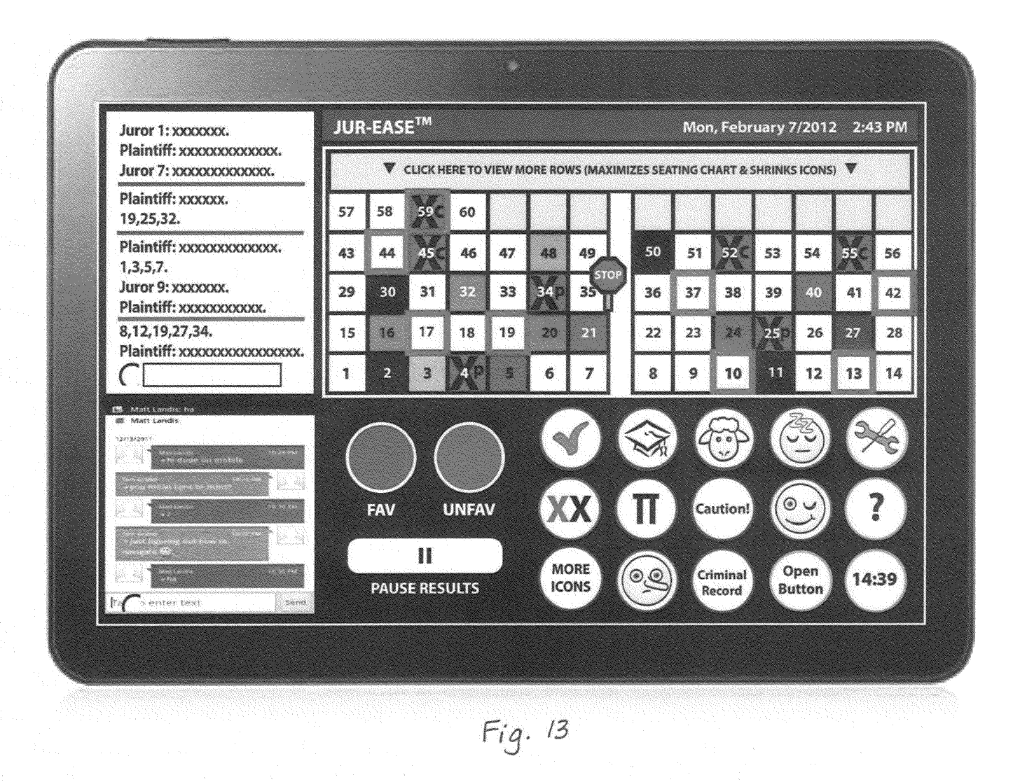

As shown in FIG. 8, the GUI may include a graphical representation of a prospective juror seating chart. The graphical juror seating chart may identify each prospective juror by a number, name, symbol, or other suitable designation. The GUI may include selectable options to print juror cards; print jury panel lists; print seating charts; shuffle the jury pool (e.g., using a random generator to re-assign seats); make strikes for cause; make peremptory strikes; print a master jury pool list; print a final jury list; return to check in; and return to main menu. The GUI may also provide a graphical indication of prospective jurors who have been stricken, as evidenced by the prospective juror boxes marked with a large “X,” for example, and may further provide a graphical indication of the reason or basis for the strike, such as a “C” for cause or a “P” for peremptory (see FIGS. 12-13), for example. The GUI may also provide an annotated, scrollable juror list sortable by a desired criterion, such as juror number, seat number, name, or notes. The juror information may be constantly updated during the jury selection process so that all user's have the latest, up-to-the-minute information at all times in light of changes made by the clerk, attorneys, or other users.

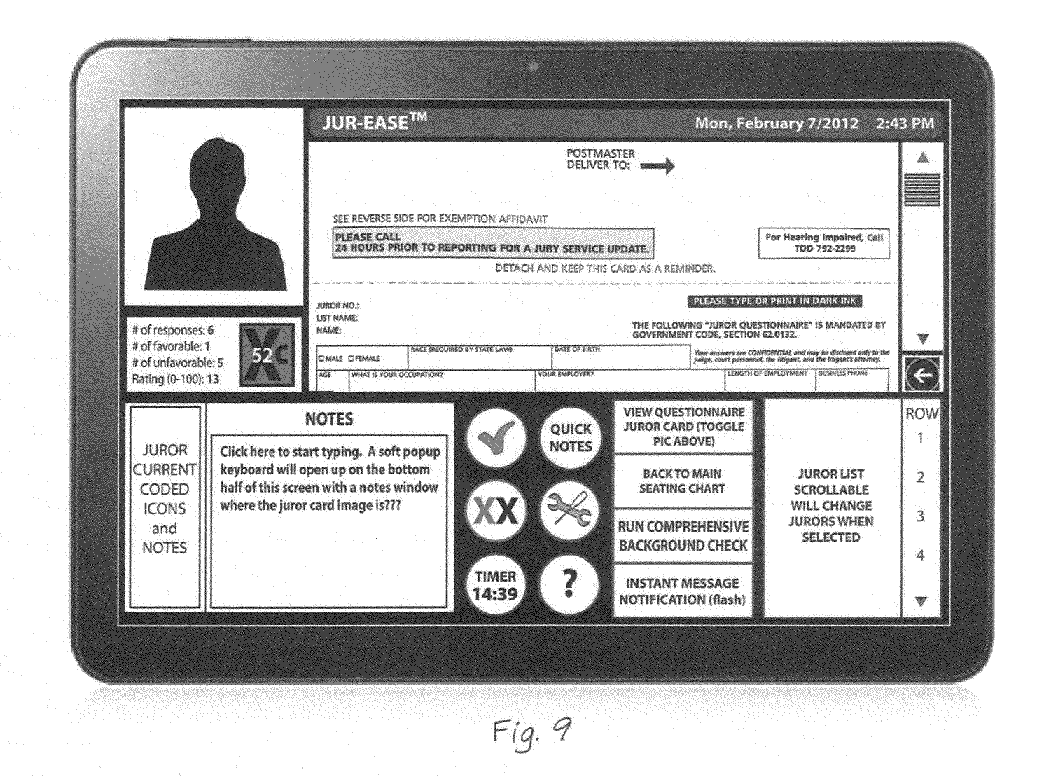

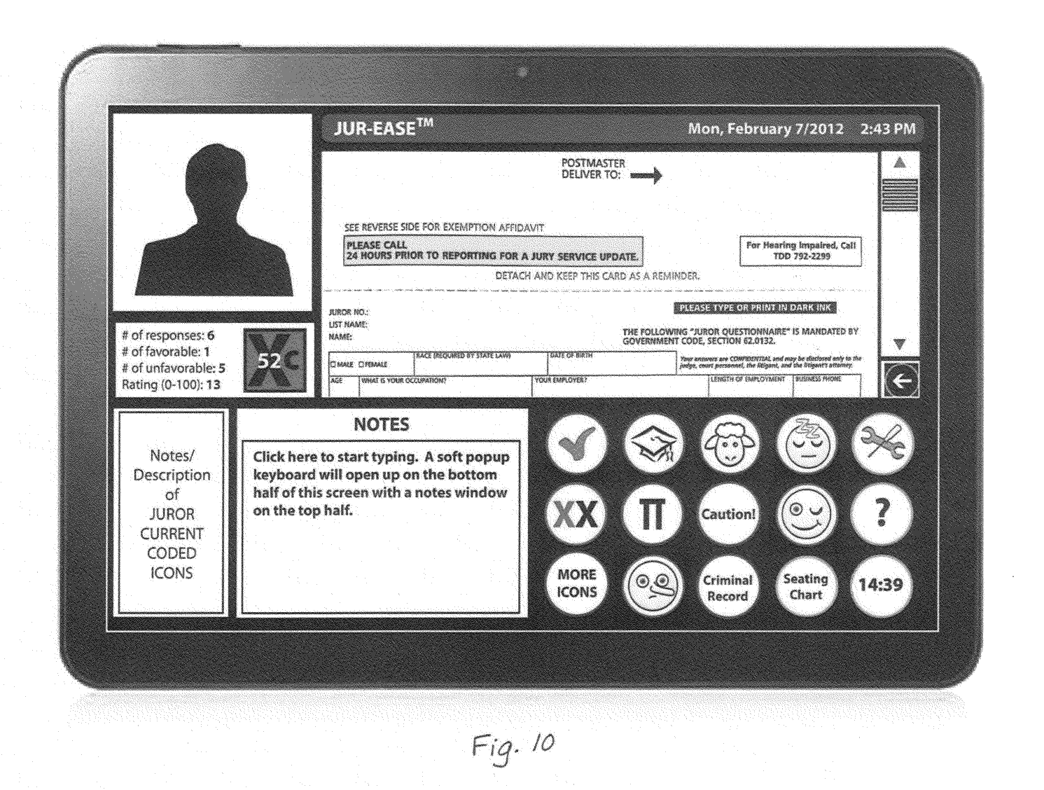

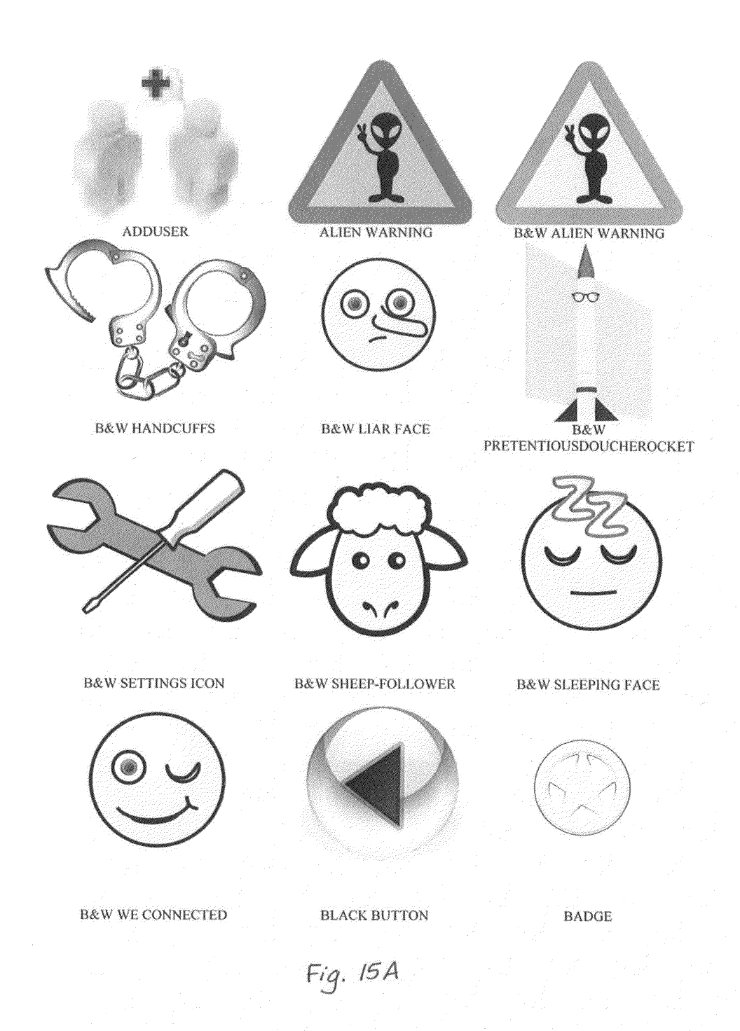

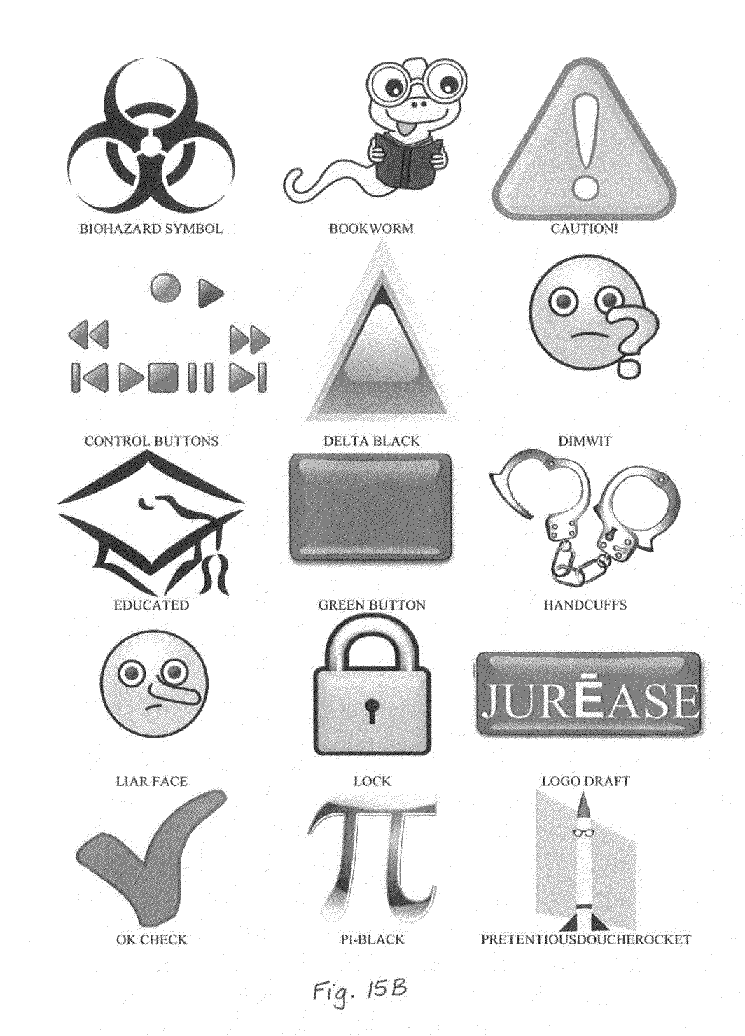

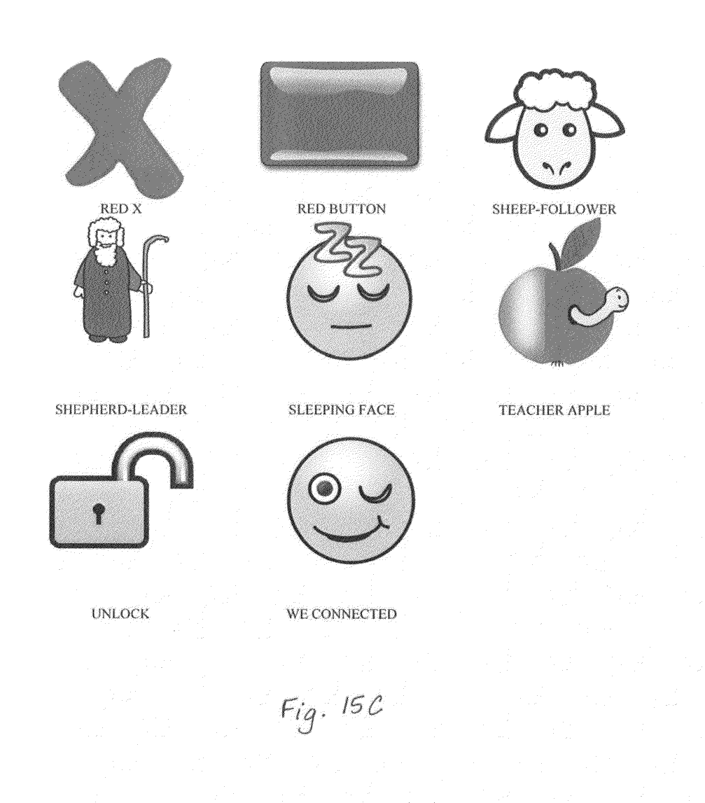

As shown in FIG. 9, the GUI may include a representation of the juror card for each prospective juror. The GUI may also include a photograph of each prospective juror associated with the respective juror card. The GUI may also allow the user to view a prospective juror card questionnaire; go back to the main menu seating chart; run a comprehensive background check; or send a message (e.g., email, instant message, or the like) to another user. The GUI may also allow a user to enter notes concerning each prospective juror. The GUI may also indicate data concerning the responses of each prospective juror, such as the total number of responses, the number of favorable responses, the number of unfavorable responses, and a rating for the particular juror. The GUI may also provide a graphical indication of a strike, such as a strike for cause or a peremptory strike. As shown in FIG. 10, the GUI may provide a number of icons that a user may use to provide a shorthand graphical representation of a characteristic applied to a prospective juror by the user, which may assist the user in deciding whether to strike a prospective juror. Other examples of such icons are shown in FIGS. 15A-15C. In some embodiments, if a user selects a particular icon, the system will highlight all prospective jurors who have been associated with that icon.

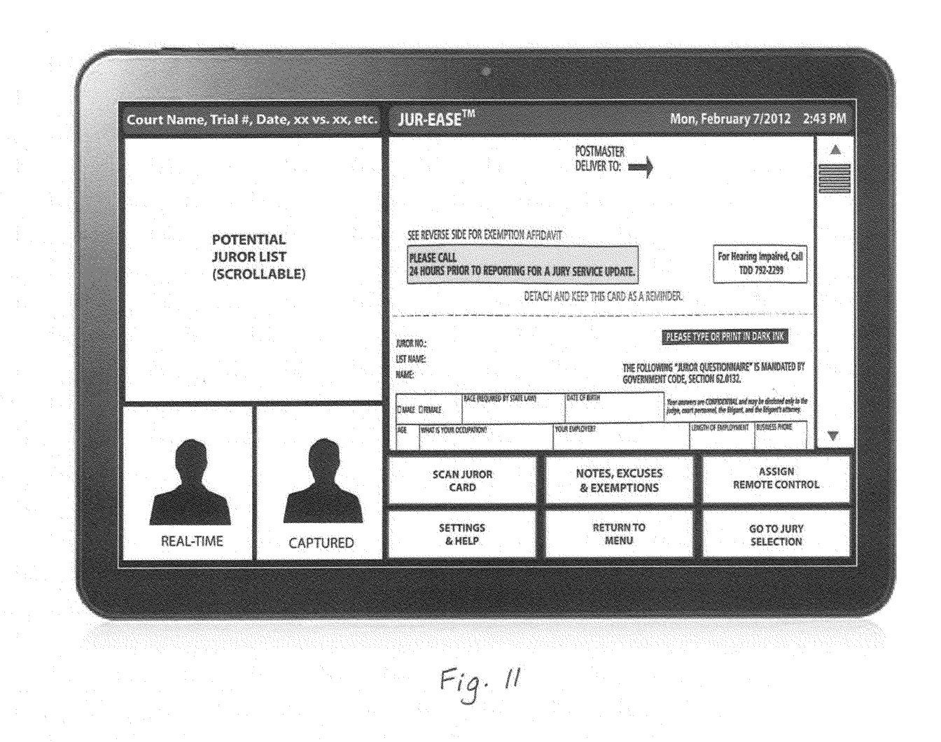

As shown in FIG. 11, the GUI may include both real-time and captured images of each prospective juror. In addition to potential juror lists, the GUI may include options for scanned juror card; notes, excuses and exemptions; assign remote control; settings and help; return to menu; and go to jury selection.

As shown in FIG. 12, the GUI may include a region having a graphical indication of actually seated jurors in addition to prospective jurors. Based on the prospective jurors' responses to juror questionnaires, the system may provide a graphical indication regarding which prospective jurors are favorable or unfavorable to a particular party, and the degree to which any given prospective juror is favorable or unfavorable to such party. For example, in some embodiments, the GUI may provide a graphical indication of red color for an unfavorable prospective juror on such prospective juror's square, and the degree of unfavorability may be indicated by a shade of red (e.g., darker shade of red for more unfavorable, or lighter shade of red for less unfavorable). Similarly, a favorable prospective juror may be indicated with a graphical depiction of green color in the prospective juror's square, and the degree of favorability may be indicated by a shade of green (e.g., darker shade of green for more favorable, or lighter shade of green for less favorable). Of course, in addition to or in lieu of color, other graphical indications may be provided to indicate a degree of favorable or unfavorable, such as the relative size or density of bars, dots, dashes, hatching, or the like. The GUI may provide an option to run a comprehensive background check for the entire prospective juror panel or an individual prospective juror so that the results of the background check may be taken into consideration during jury selection. In addition to the ability to log in or register, the GUI may provide a user an option to invite another user to use the system via an electronic message. The GUI may also provide the ability to pause the results being displayed (e.g., the indications of responses from prospective jurors to a particular question may be sustained, such as affirmative responses being continuously highlighted or otherwise displayed, for example, for an extended period of time until the user stops the pause feature in order to proceed to a subsequent question) so that the user may ask further questions of particular jurors, make notes, assign icons, or otherwise use the time during the pause before proceeding further. In some embodiments, a pause may allow a user to associate a note, icon, or other indication with all prospective jurors who have responded in a certain manner to a given question. The system may also provide a timer to provide a visual indication to a user of how much time has elapsed (counting up) or how much time remains (counting down from a specified number). The GUI may also include a graphical indication of messages transmitted between or among users in real time to allow users on the same team (e.g., plaintiff or defendant) to collaborate further during the jury selection process. In some embodiments, a “Stats” icon may be selected which will allow an attorney to pull up various graphical representations of the response data for a selected question. For example, the total number of responses for each possible response to a question may be displayed in numerical or graphical form (e.g., line graph, bar graph, pie graph, raw response numbers, percentages, or the like). In some embodiments, an attorney may select a particular question and the system will provide the response statistics for that particular question (e.g., average, mean, standard deviation, or the like).

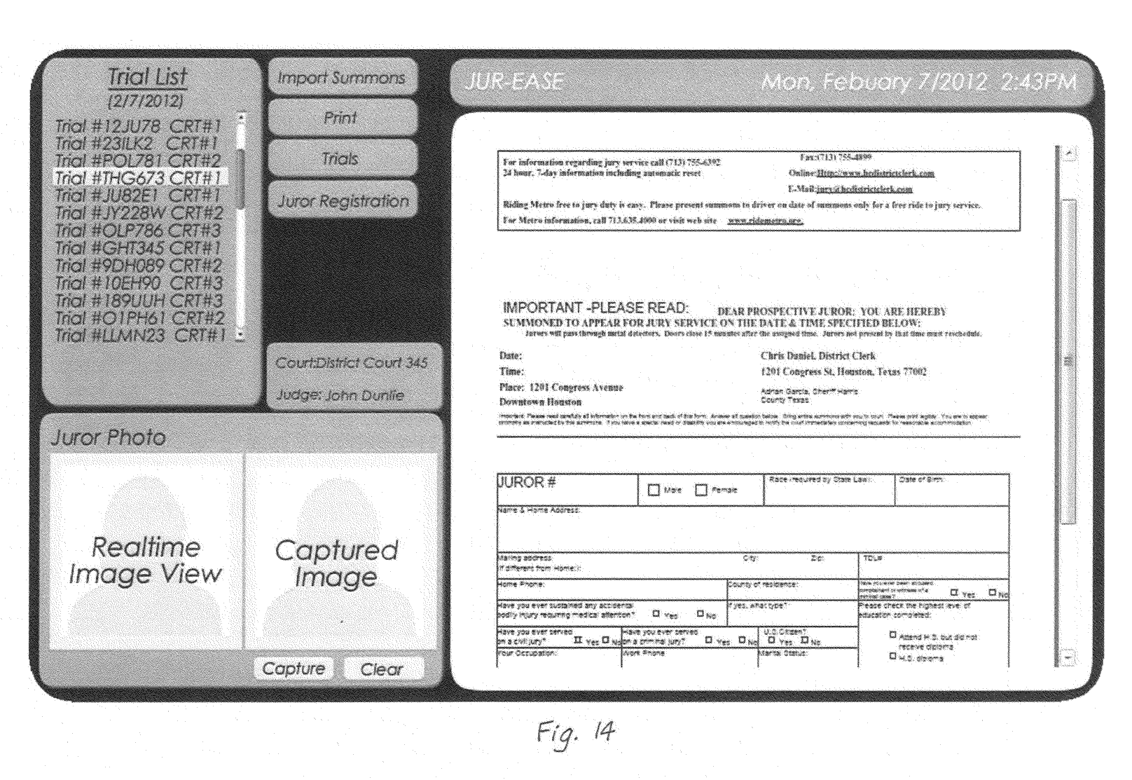

As shown in FIG. 14, a court clerk's module may include a selectable trial list to allow the clerk to select a particular trial, import the summons for the particular trial, print prospective juror lists, and enter juror registration data. The GUI for the court clerk's module may also provide a real time image view and a captured view of a juror photo.

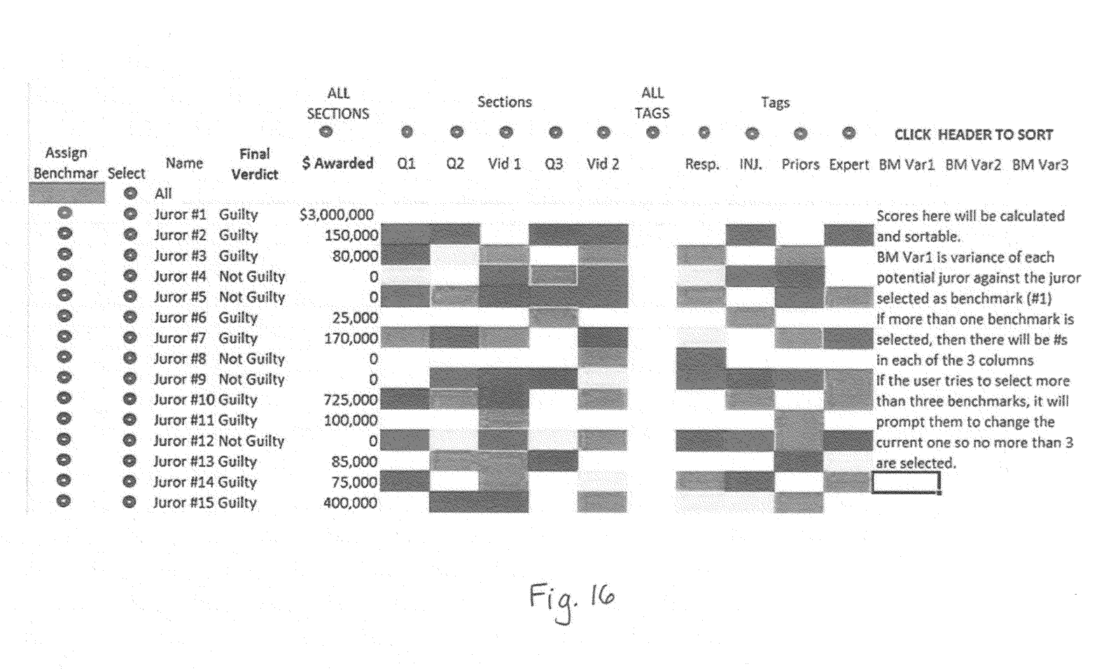

Referring to FIG. 16, in some embodiments, a consulting module may include a feature that generates a color-coded or other graphical indication of variances of the responses of jurors from the responses of a benchmarked juror, as follows:

Main Interface for Sorting Data and Choosing which Data to View to Sort, Organize and Display:
a) As shown in FIG. 16, a table generated by the system may include the following columns:
   1) Assign Benchmark: provides a user the ability to select a listed juror as the benchmark juror against which other jurors' responses are measured.
   2) Select: provides a user the ability to select a listed juror for which to display data.
   3) Name: name or number of each juror.
   4) Final Verdict: indication of each juror's verdict (e.g., guilty or not guilty for a criminal trial; liable or not liable for a civil trial).
   5) Money Awarded: indication of each juror's money award (e.g., fine for a criminal trial; damages for a civil trial).
   6) Sections: color-coded indications representative of variances of the responses of each juror from the responses of a benchmarked juror for each of a series of questions, live presentations, video presentations, or other sections (e.g., Questionnaire #1, Video #2, live presentation, etc.).
   7) Tags: color-coded indications representative of variances of the responses of each juror from the responses of a benchmarked juror for each of a series of tagged questions, live presentations, video presentations, or other sections that have been tagged by a user (e.g., a user may tag a plurality of questions and the associated answers as pertaining to a certain category, such as proportionate responsibility, liability, injury, prior convictions, expert witnesses, or the like, and the responses/variances for such category may be displayed). All or selected ones of the tags, which may be preconfigured or user-defined, may be displayed.
   8) Benchmark Variance: If a benchmark juror is assigned by selecting a radio button as described in b) below, the system may compute and display a score for each juror indicative of the variance across the total session (all Sections or sub-sections) or across selected Sections (e.g., Questionnaire #1, Video #2, or the like). A user (e.g., jury consultant=JC) may select radio buttons of “select all categories” or choose one to several sub-sections or tags. If tags are chosen and some, but not all, sub-sections, the system may calculate and display only the variance of questions that have that tag in those sub-sections (e.g., an intersection of data). However, if a user selects all Sections, the system may calculate a variance for all questions and eliminate the tags. In other words, in some embodiments, the system may not double count. If a user selects all sections, with specific tags, the system may compute and display variances only for the tags within the entire presentation. The juror response data may be sorted based on benchmark variance in either ascending and descending order.
If a benchmark juror is selected in section b) below, then all of the juror response boxes on the screen may display one of seven colors, for example, based on the variance of each juror for each section against the benchmarked juror. For example, the closer the answers of a given juror match those of the benchmarked juror within a given section, the greener the box will be. Each juror response box may be scaled and colored accordingly as a separate unit. For example, Green may be representative of a small variance, Neutral may be representative of a moderate variance, and Red may be representative of a large variance (e.g., darker=higher red or smaller green). Of course, any desired color scheme may be used, and indications other than color or in addition to color may be used. This feature will allow a user to quickly see how each juror stacks up against the benchmark juror. The user may quickly and easily change the benchmark by selecting a different juror's radio button, and the system may recompute and display the variances based on the newly selected benchmark juror.
b) As shown in FIG. 16, the screen may have the juror names/numbers with radio buttons beside each one to “assign as benchmark.” If selected, the selected juror will be assigned as the benchmark, and all applicable variances, according to which sections/tags are selected, will be calculated and displayed in comparison to the selected benchmark juror.

Continuous Comparative Interactive Feedback (Real-Time Jury Consultant)

Several options for scoring and displaying juror response data may be provided as follows:
a. No benchmark may be used, and instead the system may score each juror against a predefined scale (e.g., −3 to 3)—raw scores at each point may be marked;
b. An Attorney, jury consultant (ringer), or other user may act as the benchmark by interacting real-time as a participant—e.g., as a hypothetical ideal juror;
c. A user may manually select one respondent/juror (e.g., after the full presentation is complete) as the benchmark. In some embodiments, this one respondent's line graph of responses may be colored, while all the other ones may be black. This will help the JC to find patterns and discrepancies (divergences) in answers. When the JC hovers over a data point or line, then the associated juror's name and question # may pop up to quickly go to that information;
d. A user may manually select up to three respondents/jurors (e.g., after the full presentation is complete) that are colored and set as a benchmark. The same or different scoring system may be used as the above described benchmark, but each participant may now have up to three scores by their line of data points to compare against the three selected benchmarks. In addition, if 3 benchmarks are chosen on the main data spreadsheet selection page, there will be data displayed in BM2 variance and BM3 Variance (although the illustrated example shows 3 benchmarks, any suitable number may be provided); and/or
e. The consultant may add tags during the real-time process. A tag may be user defined so that a question tagged may be included in a desired column of data having that tag.

Questionnaire Scaling
a) All questions may be scaled on a desired scale (e.g., −3 to 3 points) for each possible answer to each question (e.g., True/False, multiple choice, scale of 0-10 or 0-100, very favorable of scaled likeability, or score for each discrete variable (e.g., Christian, Islamic, etc.)). The ideal score for each question may be considered the benchmark. Although a seven-point scale is illustrated, any suitable scale may be used.
b) Each potential juror may be scaled against the benchmark using a desired variance formula. For example, the absolute value of the difference may be used for each question and may be calculated across all questions in each sub-section, all the sections, by user created/selected tags, or the like. All the answers may be displayed as a line graph, bar graph, pie graph, or the like. The Benchmark may be highlighted and each other one may be black or other distinguishing color if all are shown or if, for example, five or fewer jurors are selected, they may be shown as individual colors. The variance for scores of each individual juror against each benchmark (up to 3, for example) may be able to be sorted as it. Benchmark variance columns may be labeled BM1 Var, BM2 Var, BM3 Var, for example. Any suitable formula may be used to compute an overall variance score, such as sum, sum of squares, average, weighted average (e.g., with suitable weights being assigned to each question), or the like.
   In some embodiments, a jury consultant or other user may code each answer to each of several different types of questions (e.g., T/F, multiple choice, −3 to +3, 0 to 10, discrete variables—e.g. religion, multiple-part questions, or the like). In some embodiments, multi-part (e.g., 2-part) questions may be allowed. For example (first part of question): “What emotion do you feel?” The user may code each emotion on a scale of −3 to +3, and the second part of the question may be, “How strongly do you feel that emotion?” For example, as the second part, a multiplier on a scale of 1-10 may be applied to the response to the first part, with 10 being 100% and 1 being 10%. In this example, the multiplier (second part) times the scoring of the emotion (first part) would be the score (e.g., −3×90%=−2.7). Of course, any suitable scoring may be used.

Persons of ordinary skill in the art will appreciate that displays of juror response information such as that shown in FIG. 16 may significantly assist an attorney or other user in determining which jurors or other respondents/participants are favorable or unfavorable to a given party and the basis on which they are favorable or unfavorable. This information may greatly assist a user in drafting and selecting questions to be asked during voir dire and in making strikes for cause and peremptory strikes during jury selection. For example, based on such favorability information, a user may readily identify a prospective juror who is inclined to award a substantial sum of damages to a plaintiff and may look for similarities and differences among the other prospective jurors compared to the identified prospective juror.

Although “buttons” have been described above for selecting various features or functionalities, persons of ordinary skill in the art will understand that other GUI components may be used, such as pull-down menus, slider bars, check boxes, text boxes, icons, and the like.

The Appendix attached hereto, which is incorporated herein by reference, provides an example of some illustrative software and data structures that may be used in practicing the systems and methods described herein. Of course, other software and data structures may be employed to practice the systems and methods described herein.

The embodiments described herein are some examples of the current invention. Various modifications and changes of the current invention will be apparent to persons of ordinary skill in the art. Among other things, any feature described for one embodiment may be used in any other embodiment. The scope of the invention is defined by the attached claims and other claims to be drawn to this invention, considering the doctrine of equivalents, and is not limited to the specific examples described herein.

### APPENDIX

The following is an example of some software and data structures known as the Jur-Ease™ jury consulting tool developed by Jur-Ease, LLC (Kerrville, Tex.) that may be used in practicing the systems and methods described above. All values and quantities stated herein are exemplary only; any desired values and quantities may be used, depending on the desired application.

1.0 [reserved]

2.1. Website Database
2.1.1. The database will be developed in Postgres SQL.
2.1.2. Create hierarchy for login credentials
2.1.3. Registration Information
   2.1.3.1. Attorney name
   2.1.3.2. Attorney address
   2.1.3.3. Type of account purchased
   2.1.3.4. Billing information
   2.1.3.5. Online payment capability
2.1.4. Case Information
   2.1.4.1. Case Name (who vs. who)
   2.1.4.2. Case Number
   2.1.4.3. Location by City, County or Parish, and State
   2.1.4.4. Type of case
   2.1.4.5. Judges Name
   2.1.4.6. Plaintiff Attorneys Name
   2.1.4.7. Defendant Attorneys Name
   2.1.4.8. Date
   2.1.4.9. Outcome of case
2.1.5. Jurors—Information from Local database Clerk Module—below is a sample of fields required. There may be up to 20 or more fields for juror information. Information may be from Secretary of State and Juror card developed in Jur-Ease.
   2.1.5.1. Name
   2.1.5.2. Age
   2.1.5.3. Ethnic Group
   2.1.5.4. Male or Female
   2.1.5.5. Jury size
   2.1.5.6. Provide website location for jurors to register online. Jurors may have the ability to edit their information in some embodiments.
      2.1.5.6.1. List of data required on website will be the same as required on the jurors card. This information will be pushed to all modules for that particular jury selection.
      2.1.5.6.2. Any preloaded custom questionnaires or data queries will also be pushed to all modules for that particular jury selection.

2.2. Local database
2.2.1. The local database will also be developed in Postgres SQL.
2.2.2. The local database will control the following:
   2.2.2.1. Clerk Interface
   2.2.2.2. Defendant Interface
   2.2.2.3. Plaintiff Interface
   2.2.2.4. Judge Interface
   2.2.2.5. Court Reporter Interface
   2.2.2.6. Wi-Fi for laptop or tablet login
   2.2.2.7. Wireless voting devices
   2.2.2.8. Receiver for wireless voting devices
   2.2.2.9. Camera for photos of jurors
   2.2.2.10. Card scanner
   2.2.2.11. OCR software
   2.2.2.12. Printing ptions
   2.2.2.13. Internet connection with website database server.

2.3. Clerk Module
2.3.1. Develop as a web application running on local appliance:
2.3.2. Ability to import Secretary of State juror summons information in either CSV or XML format.
   2.3.2.1. Ability to mail merge and print juror cards/summons/exemptions.
2.3.3. Open new or view previous/current trials.
   2.3.3.1. Enter/edit data for trial:
      2.3.3.1.1. Type of trial—civil or criminal
      2.3.3.1.2. Number of strikes available to each attorney
      2.3.3.1.3. State
      2.3.3.1.4. Court type
      2.3.3.1.5. Court Name
      2.3.3.1.6. Location
      2.3.3.1.7. Parties
      2.3.3.1.8. Counsel
      2.3.3.1.9. Counsel contact information
      2.3.3.1.10. Number of jurors
      2.3.3.1.11. Number of alternates
      2.3.3.1.12. Date
      2.3.3.1.13. Status updates
   2.3.3.2. User ID, Password, PIN for attorneys
      2.3.3.2.1. Assign and email to Plaintiff attorney
      2.3.3.2.2. Assign and email to Defendant attorney
   2.3.3.3. Input and edit Juror List and Juror Information
   2.3.3.4. Configure seating chart
2.3.4. Juror check-in/registration
   2.3.4.1. Scan juror information card
      2.3.4.1.1. System will prompt for missing data
      2.3.4.1.2. Fields editable to enter missing or incorrect data
   2.3.41. Each juror card will have a default time, date, and location.
   2.3.4.3. The system will have the ability to adjust the time, date, and location.
      2.3.4.3.1. A drop down menu for time to be adjusted by the quarter hour and hour will be provided.
      2.3.4.3.2. A drop down menu for date adjustment will be provided.
      2.3.4.3.3. Location changes will be a text box.
      2.3.4.3.4. All changes, once accepted will update the default time in the system for all modules.
   2.3.4.4. Edit/confirm juror information if registered online through the Jur-Ease system.
   2.3.4.5. Scan custom questionnaires that have been created through the Jur-Ease system.
   2.3.4.6. Take and enter photos of jurors.
      2.3.4.6.1. Update photo to both Plaintiff and Defendant attorney's devices.
      2.3.4.6.2. Update photo on judge's device.
   2.3.4.7. Exemption or excuse option for each juror. This will be drop down menu of options listed on juror card.
   2.3.4.8. Assign a voting device (FOB) to each juror.
      2.3.4.8.1. Test each FOB to assure it is working correctly.
      2.3.4.8.2. Ability to reassign a new FOB in case of a nonworking one issued.
   2.3.4.9. Red Flag potential jurors—these will show up as red flags in the seating charts for all systems.
   2.3.4.10. Submit Juror List for proceedings.
      2.3.4.10.1. Send Juror List to the attorney's devices and the judges' device.
   2.3.4.11. Create and view seating chart—available on all devices.
   2.3.4.12. Print Capability:
      2.3.4.12.1. Juror List
      2.3.4.12.1.1. Juror number
      2.3.4.12.1.2. Juror name
      2.3.4.12.1.3. Seat number
      2.14.12.2. Seating Chart
      2.3.4.12.3. Juror information card with picture
      23.4.12.4. Exemptions/Excuses (during voir dire)
   2.3.4.13. Shuffle capability—ability to create a new seating chart using a random generator.
   2.3.4.14. Ability to strike potential jurors for cause (blacks out seat on all modules).
   2.3.4.15. Request/Receive Peremptory Strikes submitted by attorneys.
   2.3.4.16. Print the strike list for the court record.
   2.3.4.17. Finalize and print the jury list.
   2.3.4.18. Enter outcome of trial.

2.4. Attorney Software Module—run on both local and website server
2.4.1. Silver Level (basic viewing)
   2.4.1.1. Seating chart.
   2.4.1.2. Pop-up of juror information.
      2.4.1.2.1. Juror photo
      2.4.1.2.2. Juror seat number
      2.4.1.2.3. Juror number
      2.4.1.2.4. Scan of juror card
   2.4.1.3. Ability to enter peremptory/for cause strikes.
2.4.2. Gold Level—includes all Silver level services plus the following:
   2.4.2.1. Ability to create custom questionnaires through the Jur-Ease system. (Additional fee to create questionnaires)
   2.4.2.2. Seating chart with pre-coded seat colors (scale 1-7) based on questions from the juror card and any custom questionnaires. Questions are pre-coded by attorney before voir dire as favorable or unfavorable.
   2.4.2.3. When attorney asks a question, the system will record the answers of yes, no, or abstain that the prospective juror selected on the FOB.
      2.4.2.3.1. A graph at the top of the page will show the number of yes's, no's, and abstains. The graph will appear as quickly as the system can update. The FOB answer is recorded by the FOB Receiver, which then sends the info to the server. The server then updates the database in the Jur-Ease system which will then update the tablets wirelessly. There could be about a 1-2 second delay on the graph appearing on the screen.
      2.4.2.3.2. The attorney can select a seat number for a prospective juror and see the number of yes's, no's, and abstains for that juror.
      2.4.2.3.3. In case the attorney forgets to select the next question button, if 10 percent or more of the FOB's are pressed, the system will automatically move to recording and graphing for the next question. (This feature could train attorneys that there is no need to press the next question button and could possibly lead to answers being recorded for the wrong question if done repeatedly).
      2.4.2.3.4. On the left side of the User Interface—the attorney will be able to click on any red or green question that has been coded into the system and see the statistics for that particular question. Will be in the transcript if available for that jury selection.
   2.4.2.4. Note taking capability for each juror.
   2.4.2.5. Assign “quick icons” to any juror.
   2.4.2.6. Icon button—press the icon button and all icons in the system appear (up to 10 icons).
      2.4.2.6.1. Attorney will have ability to select an icon and assign it to one or more seat numbers.
      2.4.2.6.2. Attorney can select another icon and assign it to one or more seat numbers.
      2.4.2.6.3. Attorney selects save, and those icons appear on the seat numbers previously selected
   2.4.2.7. When a juror answers affirmatively to a question, their seat is highlighted on the seating chart.
   2.4.2.8. Instant messaging client—restricted by login to prevent Plaintiff and Defendant crosstalk.
   2.4.2.9. Real-time searchable transcript with time-stamped responses and questions coded by color as favorable or unfavorable.
   2.4.2.10. Real time trending based on the coding of questions. This would indicate a juror as trending favorable or unfavorable.
   2.4.2.11. View strikes for cause on seating chart (this information is entered through the Clerk Module)
   2.4.2.12. Record/suggest strikes for cause (these would be time stamped and integrated in the real time transcript and viewable on the juror information screen).
   2.4.2.13. Submit peremptory strikes
   2.4.2.14. Maximum Jury Quick Glance—see highest potential juror seat number to be included in jury at any time (noted by STOP sign or other suitable designation)
   2.4.2.15. Preset quick selects to de-clutter screen (there may be 2-3 more options):
      2.4.2.15.1. Strikes for cause
      2.4.2.15.2. Peremptory strikes
      2.4.2.15.3. Only green jurors
      2.4.2.15.4. Only red jurors
   2.4.2.16. Hover feature—moving mouse over juror seats to view basic info about juror.
      2.4.2.16.1. Name
      2.4.2.16.2. Seat number
      2.4.2.16.3. Trending
      2.4.2.16.4. Click again to go to full juror information.
2.4.3. Platinum Level—includes all Gold Level services plus the following:
   2.4.3.1. Ability to create additional custom questionnaires through the Jur-Ease system. (Additional fee to create questionnaires).
   2.4.3.2. Real time color coded trending during voir dire based on selected algorithms.
   2.4.3.3. Data analysis based on pre-coded questions/juror information (this module may be based on nationwide database of juror information and trial outcomes).

2.5. Judge Module—run on both local and website server
2.5.1. View seating chart.
2.5.2. View exemption requests submitted by clerk
2.5.3. View strikes for cause.
2.5.4. View juror number.
2.5.5. View juror card.
2.5.6. View juror photo.
2.5.7. View final jury.

2.6. Jury Consulting Module
2.6.1. Will have basic functionality of Jur-Ease.
2.6.2. Jury consulting model will consist of 3 main options:
   2.6.2.1. Online surveys—questionnaires created in the system should be able to be scanned into Jur-Ease. Surveys or questionnaires created outside the Jur-Ease system will have to be manually entered or uploaded.
   2.6.2.2. Focus groups
   2.6.2.3. Mock trial
2.6.3. Utilize same database as Jur-Ease.
2.6.4. Track trending of topics vs. trending of juror answers.
2.6.5. Time stamp each question (questions may be preloaded into system)
2.6.6. Focus will be on tracking favorable or unfavorable topics.
2.6.7. User Interface differences may be developed.
2.6.8. Jury consulting module will be able to capture audio from lapel mike and store in system for up to two (2) weeks.
2.6.9. On login to the system, a prompt will appear to notify users they have recordings that need to be downloaded before the system deletes them.
2.6.10. Focus Groups
   List of names: Import from CSV/.xls or use the system to generate list with names, addresses, age, sex (juror questionnaire/card fields)
   Generate name tags/name tent so consultant can read names (JUROR 1: First name, Last initial)
   Generate form letters (to show up with date and time—mail merge) will have summons and signature spot for confidentiality
   Create a custom “juror card” for them to mail out, online, or on location, with same fields as clerk module (standard form, plus they can add fields or remove fields)
   Create questionnaires with instructions/rules page, session one like a standardized test (create a standard one and also allow jury consultants to change verbiage if they want)—question template (i.e. make statement, true/false, scaled question (1-10), multiple choice, #
   Bar code on each page and knows which question the data is for
   Data base of questions with categories/sections. When the consultant creates custom questionnaires, they have the option to add the question(s) into the database and also sort by category.
   Name merge tokens/fields so that name can be changed (e.g. plaintiff or defendant)
   Handwritten notes will be captured as images and can be grouped with all participants or by juror all answers
   Will be done on laptops
   Check-in just like clerk module (picture, clickable link)
   Summary report (create sections that they can type in and populate—i.e. executive summary)
   Issue spotting (main issues supporting or against case) with agree, strength of agreement (both key fob inputs) and notes by consultant. He/she can enter as he/she is creating the report. Statement made/inputted by consultant and then used to ask potential juror if he/she agrees or disagrees, strength of opinion and hand written notes. Capture their notes as image on form and then allow consultant to summarize.
   Verdicts (same thing—who should win versus possible defendants—may be more than one defendant and we need to know who the best chance of success is against)
   Allocation of responsibility (%/defendant(s)/other, notes on why?)
   Award, why? (notes)
   Punitive damages, why? (notes)
   Default data display (graphs, charts)
   Focus group data will be used to create online surveys or vice versa, with given trends
   Demographically correct cross-section of potential jurors used in focus group based on our nationwide data
   Issues spotting “toolbox” . . . allows the consultant to create issues on the fly (that populates drop down menu with issues to assign notes to and categorize subjective opinions; add/delete/edit name of issue (can then do statistical analysis)
   Each potential juror will have his/her own tablet to be able to enter everything in a prompted session.
   May be scantron only/scantron and key fobs/tablets

2.7. Hardware considerations
2.7.1. Main server to host website and database. Host server in a secure location. Consider redundancy with a second server.
2.7.2. Local appliance (main interface). May use a small appliance as a local web server that has Internet, WiFi, and Bluetooth capability.
2.7.3. Voting devices or FOBS—each FOB may have a unique identifier for each FOB. A receiver may accept the FOB transmission and then push that to the Jur-Ease system. Depending on the system selected, software may be developed to facilitate this operation.
2.7.4. Scanners—most scanners have software available that will run inside the system.
2.7.5. OCR capability. Depending on the OCR software chosen, there may be an OCR Library licensing fee.
2.7.6. Tablets—varying cost depending on functionality and manufacturer.
2.7.7. Webcam or camera_Webcam would be an easy solution if Clerk is using a laptop. Prospective jurors can sit in chair in front of Clerk and Clerk can take picture using a webcam clipped to top of laptop screen.

2.8. User Interface
2.8.1. A User Interface may be developed that will include selected colors, “quick icons”, screen layout, etc.
2.8.2. The UI will provide a way to adjust what appears on the screen in a preset fashion.

What is claimed is:

1. A tangible computer-readable medium comprising a program with instructions executable by a computer embodied therein, said instructions configured to cause the computer to perform the following when executed:
receiving personal data regarding each of a plurality of prospective jurors;
establishing a plurality of questions to be posed to said plurality of prospective jurors;
establishing a plurality of potential answers to each of said plurality of questions;
assigning a degree of favorability or unfavorability to each of said plurality of potential answers;
transmitting said plurality of questions to said plurality of prospective jurors;
receiving a response to each of said plurality of questions from each of said plurality of prospective jurors, each said response comprising one of said plurality of potential answers;
associating a respective one of said degree of favorability or unfavorability with each of said plurality of prospective jurors based on said response; and
generating a representation of said respective one of said degree of favorability or unfavorability for each of said plurality of prospective jurors, wherein said representation is configured for display on a display screen.

2. The computer-readable medium of claim 1 wherein:
said establishing a plurality of potential answers to each of said plurality of questions comprises receiving a user-defined benchmark answer; and
said degree of favorability or unfavorability is assigned to each of said plurality of potential answers based on a degree of departure of said response from said benchmark answer.

3. The computer-readable medium of claim 1 wherein said representation comprises a color.

4. The computer-readable medium of claim 3 wherein said color comprises a shade, and wherein said shade varies according to said degree of favorability or unfavorability.

5. The computer-readable medium of claim 1 wherein said instructions are further configured to cause said computer to perform the following when executed:
providing a plurality of selectable graphical icons each of which is indicative of a personal characteristic;
associating one or more of said plurality of selectable graphical icons with one or more selected ones of said plurality of prospective jurors in response to a selection received from a user; and
generating a representation of said one or more of said plurality of selectable graphical icons in association with a representation of said one or more selected ones of said plurality of prospective jurors.
